(19) United States
(12) Patent Application Publication
(10) Pub. No.: US 2002/0140548 A1
(43) Pub. Date: Oct. 3, 2002

(54) Method and apparatus for a vehicular wireless network

(75) Inventors: Robert Pierce Lutter, Tacoma, WA (US); Dan Alan Preston, Bainbridge Island, WA (US)

Correspondence Address: MARGER JOHNSON & McCOLLOM, P.C., 1030 SW Morrison Street, Portland, OR, 97205, US

(73) Assignee: Medius, Inc., Seattle, WA

(21) Appl. No.: 09/892,293

(22) Filed: Jun. 26, 2001

Related U.S. Application Data
(60) Provisional application No. 60/280,557, filed on Mar. 30, 2001.

(51) Int. Cl. B60Q 1/00

(52) U.S. Cl. 340/425.5

(57) ABSTRACT

A vehicular wireless network is formed by connecting a plurality of sensor devices and automobile subsystem devices to a processing unit with wireless links. Similarly, a vehicular wireless network is formed by connecting a plurality of sensor devices and automobile subsystem devices located in various compartments of an automobile to a signal interface located in the same compartment with wireless links. The signal interfaces and processing unit are then linked by a bus that is installed to run through all the automobile compartments.

This application claims the benefit of U.S. Provisional Patent Application Serial No. 60/280,557, filed Mar. 30, 2001, entitled VEHICLE NOTIFICATION SYSTEM.

### BACKGROUND

In the aircraft industry, there is a well-known phenomena where aircraft fresh off the production line typically incorporate avionics systems that were state of the art a decade ago or more. This gap exists because designs must be finalized well in advance of the production stage, as a practical matter there must be some point where a transition is made from a “paper” airplane to a functional one. It is no coincidence that roughly 70% of the lifecycle cost of a military aircraft system is composed of maintenance and subsequent upgrades necessary to keep the system viable.

The same effect is seen in the automobile industry to a certain degree. The electronics begin to age as soon as the design is finalized, but since wiring harnesses cannot easily be modified after installation, after-market modifications are prohibitively expensive. Even simple GPS navigation systems exist only in top-of-the-line automobiles, and if other options or safety features are later made available the consumer must typically purchase a brand new vehicle to enjoy those benefits.

The present invention addresses this and other problems associated with the prior art.

### SUMMARY OF THE INVENTION

The present invention comprises a method and apparatus to connect assorted vehicle subsystems, sensors, communication devices, and other electronic devices to a processing unit by using a plurality of wireless links.

### BRIEF DESCRIPTION OF THE DRAWINGS

FIG. 1 is a block diagram illustrating a first embodiment of the present invention.

FIG. 2 is a block diagram illustrating a second embodiment of the present invention.

FIG. 3 is a block diagram of a specific instance of a vehicular wireless network according to the first embodiment of the present invention disclosed in FIG. 1.

FIG. 4 is block diagram of a specific instance of a vehicular wireless network according to the second embodiment of the present invention disclosed in FIG. 2.

FIG. 5 is a stylized profile of an automobile illustrating the physical location of some of the components described in FIG. 4.

### DETAILED DESCRIPTION

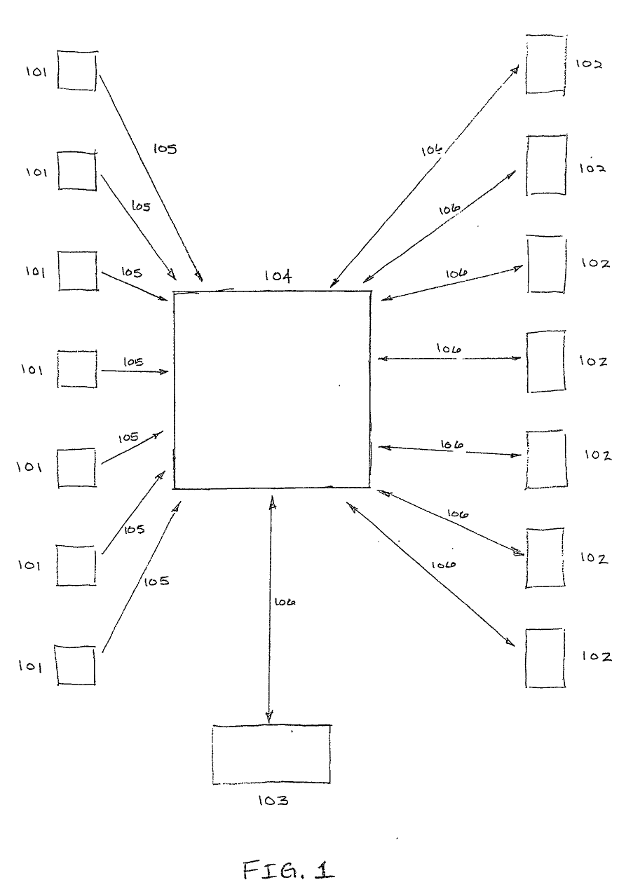

FIG. 1 is an illustration of a first embodiment of the present invention. FIG. 1 depicts a plurality of sensor devices 101 located aboard an automobile. Though each of the sensors 101 is annotated with the same number, this is merely to indicate that the sensors perform similar functions, and not to suggest that each of the sensor devices 101 is exactly the same. Rather, each of the devices 101 could be an IR sensor, a radar sensor, or another variety of sensor placed to monitor any condition within the automobile or exterior to the automobile that may be of use when implementing collision avoidance, situational awareness, navigation, or system diagnostic functions.

Each of the sensor devices 101 is linked to a processing unit 104 located within the automobile by a plurality of wireless links 105. The wireless links 105 are unidirectional in nature, because the sensor devices 101 typically transmit only raw data to processing unit 104.

There is also a plurality of devices 102 linked to the processing unit 104 by a plurality of bidirectional wireless links 106. Again, the similar numbering system merely indicates that they are a class of devices that both transmit and receive data from the processing unit, and does not imply that each of the devices 102 is exactly the same. For example, it is anticipated that the class of devices 102 might include a security system, an environmental control system, a number of audio and video entertainment devices, a cellular phone, a GPS receiver and antenna, or personal digital assistants (PDA). In general the devices 102 will be located within the automobile. However, some of the devices may be located outside the automobile, as in the case of a cellular phone or PDA.

There is also a graphic user interface (GUI) 103 located in the automobile and linked to the processing unit 104 by a bidirectional wireless or hardwired link 106. The GUI is the means by which the driver of the automobile can input commands to control a variety of the devices 102. The driver also receives system status data at GUI 103 from the processing unit 104. There are a variety of forms that GUI 103 may take, including a touch-screen display or heads-up display similar to those typically found in military aircraft. Processing unit 104 may transmit data directly to GUI 103 from sensor devices 101 or may first perform a sensor fusion operation when multiple sensors are monitoring the same condition. Processing unit 104 may also transmit data received from one or more of the devices 102 to GUI 103.

The uni-directional wireless links 105 and the bi-directional wireless links 106 may be one of several types, depending upon the specific sensor or system that is wirelessly linked to the processing unit. For example, one of the sensor devices 101 might require an IEEE 802.11 protocol, while one of the devices 102 utilizes a Motorola Bluetooth link. In addition to the 802.11 and Bluetooth links mentioned, the processing unit 104 has the capability of interfacing with sensor devices 102 or devices 103 using an analog cellular link, a Cellular Digital Packet Data (CDPD) link, a Satcom link, or a hardwired link.

Finally, the number of sensor devices 101 and 102 or the pattern in which they are depicted in FIG. 1 should not be considered a limitation. The number of devices 102 and 103 and the physical location of 101, 102, 103, and 104 within the automobile will vary depending on the specific design.

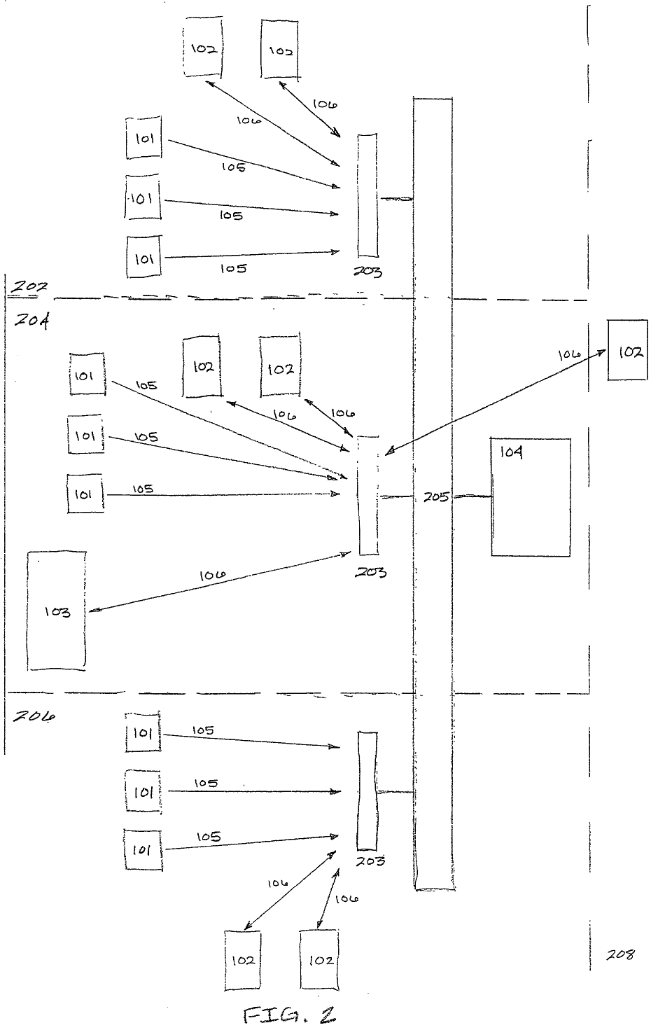

FIG. 2 is an illustration of a second embodiment of the present invention. Like the first embodiment depicted in FIG. 1, there are a plurality of sensor devices 101, a plurality of devices 102, a GUI 103, and a plurality of one-directional wireless links 105 and bi-directional links 106. The dashed lines divide the interior of an automobile into separate zones, with the engine, passenger, and trunk compartments represented by zone 202, 204, and 206, respectively. Zone 208 represents the area outside the automobile. The number of devices and wireless links located in each zone is arbitrary, there may be more or less depending on the specific design.

Each of the devices 101, 102, and 103 is wirelessly linked with a signal interface unit 203 that is located in the same zone. The signal interface units 203 are coupled to a bus 205 that is installed to run throughout all zones of the automobile. The processing unit 104 is also coupled to the bus 205. Once signals are received by the signal interface units 204, they may be placed on bus 205 and transmitted to the processing unit 104. Similarly, signals are transmitted from processing unit 104 to devices 102 and GUI 103 via the bus/signal interface route. Device 102 is located outside of the automobile in zone 208 to indicate that there may be devices such as PDAs or cellular phones that receive or transmit data to the processing unit 104 via a bidirectional wireless link.

This zone/bus structure takes advantage of the natural shielding offered by the different structural compartments of an automobile. Each zone contains a single signal interface unit that serves as the point where wireless signals are received and transmitted in each zone. The number of zones may vary depending on the type of automobile that the invention is installed in. For example, a sport-utility vehicle would require only two signal interface units 203 because it effectively has only two zones, the engine and passenger/cargo compartment. The processing unit 104 is shown located in zone 204, but it might be moved to any zone depending on the space requirements of specific designs.

Both embodiments of the present invention described above will facilitate detection of people within the automobile, and based upon detection various functions may be implemented by processing unit 104. For example, if a subset of the sensor devices 101 happened to be IR sensors installed in the passenger compartment of an automobile, the sensors can indicate when a person is within the vehicle. Based upon this occupancy data, the processing unit could operate the lighting system more efficiently by turning off the dome light when the vehicle is parked and the last occupant leaves the vehicle, rather than the usual automatic shut off. As another example, typically keys must be in the ignition to operate the car radio and environmental controls. These systems could be enabled merely by a person's presence in the vehicle. The invention could also prevent airbags from being deployed in an accident for passenger seats where no passenger is sitting. An alarm system could be configured to disable the ignition when an unauthorized occupant is detected or to call 911 with the current location of the vehicle taken from the GPS system.

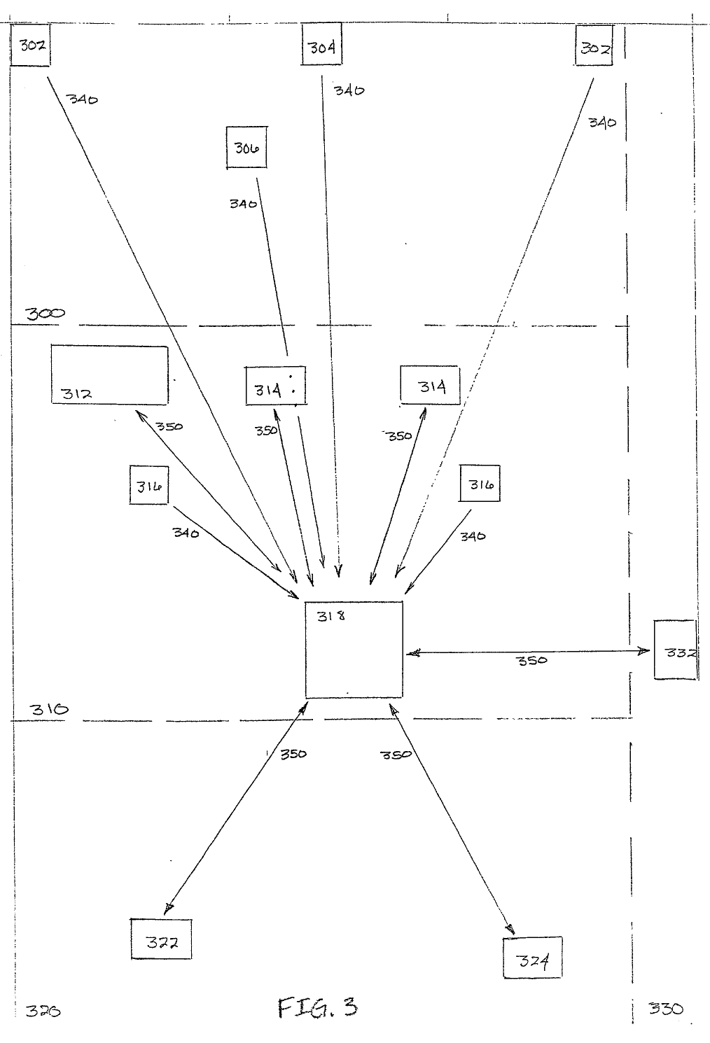

FIG. 3 is a specific instance of a vehicular wireless network according to the first embodiment of the present invention disclosed in FIG. 1. The dashed lines in FIG. 3 indicate an engine compartment region 300, a passenger compartment region 310, a trunk compartment region 320, and a region 330 that represents the area external to the automobile.

Engine compartment 300 contains two IR sensors 302 that face forward to pick up heat signatures emanating from other automobiles. Sensor 304 is a RF transmitter, receiver, and antenna that detects other automobiles. Sensor 306 is a thermal sensor to monitor engine temperature. Each of the sensors 302, 304, and 306 wirelessly transmits data to the processing unit 318 located in the passenger compartment 310 of the automobile with an IEEE 802.11 wireless link 340.

Passenger compartment 310 contains a touch screen display 312 which allows the driver to see the status of various vehicle subsystems along with providing a means to input commands. Car audio components 314 are also located within the passenger compartment. Touch-screen display 312 and car audio components 314 are linked to the processing unit 318 by bidirectional wireless Bluetooth links 350. Additionally, two IR sensors 316 are installed to monitor the occupancy state of the automobile. The two sensors 316 are linked to processing unit 318 by wireless IEEE 802.11 links 340.

Trunk compartment contains GPS receiver and antenna 322 and multiband cellular receiver/transmitter/antenna 324. The GPS subsystem 322 and cellular subsystem 324 are linked to processing unit 318 in the passenger compartment via bi-directional wireless Bluetooth links 350.

A mobile PDA unit 332 is located outside of the automobile in region 330, transmitting data to and receiving data from processing unit 318 via bi-directional Bluetooth link 350.

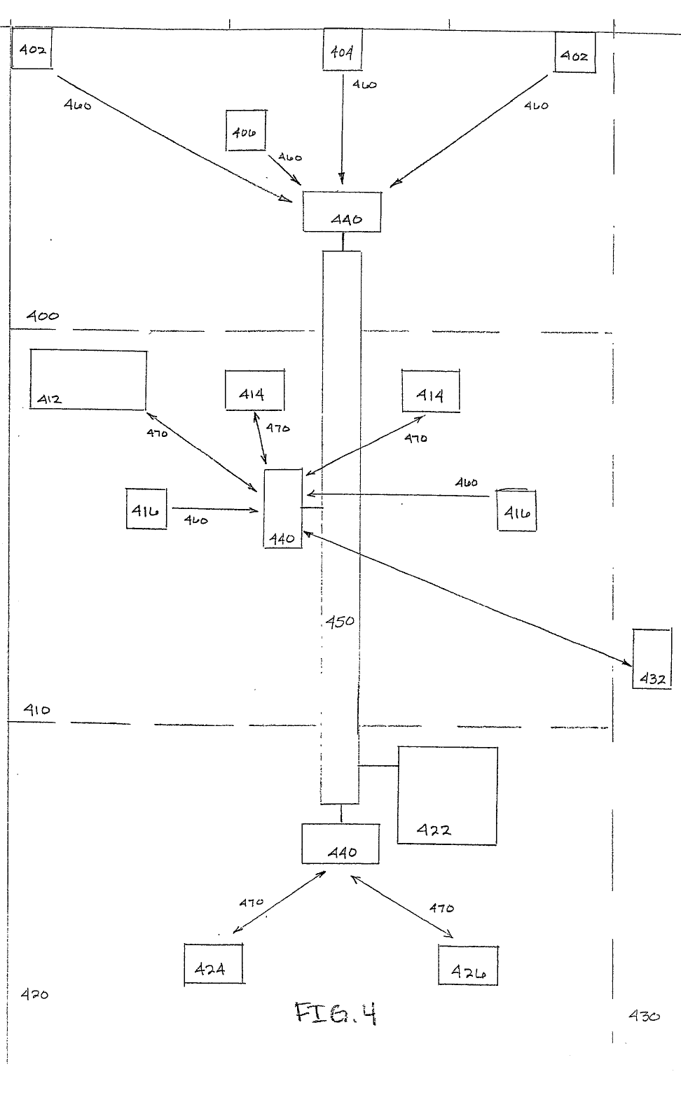

FIG. 4 is a specific instance of a vehicular wireless network according to the second embodiment of the present invention disclosed in FIG. 2. The dashed lines in FIG. 4 indicate an engine compartment region 400, a passenger compartment region 410, a trunk compartment region 420, and a region 430 that represents the area external to the automobile.

Engine compartment 400 contains two IR sensors 402 that face forward to pick up heat signatures emanating from other automobiles. Sensor 404 is a RF transmitter, receiver, and antenna that detects other automobiles. Sensor 406 is a thermal sensor to monitor engine temperature. Each of the sensors 402, 404, and 406 wirelessly transmits data to the signal interface unit 440 located in the engine compartment 400 with IEEE 802.11 wireless links 460.

Passenger compartment 410 contains a touch screen display 412 which allows the driver to see the status of various vehicle subsystems along with providing a means to input commands. Car audio components 414 are also located within the passenger compartment. Touch-screen display 412 and car audio components 414 are linked to a second signal interface unit 440 by bi-directional wireless Bluetooth links 470. Additionally, two IR sensors 416 are installed to monitor the occupancy state of the automobile. The two sensors 416 are linked to the second signal interface unit 440 by wireless IEEE 802.11 links 460.

Trunk compartment 420 contains GPS receiver and antenna 424 and multiband cellular receiver/transmitter/antenna 426. The GPS subsystem 424 and cellular subsystem 426 are linked to a third signal interface unit 440 located in the trunk compartment via bidirectional wireless Bluetooth links 470.

A mobile PDA unit 432 is located outside of the automobile in region 430, transmitting data to and receiving data from the second signal interface unit 440 via bi-directional Bluetooth link 470. The mobile PDA unit 432 can link to any of the signal interface units 440 within the automobile, it is merely shown connected to the second unit in the passenger compartment by way of example. Each of the signal interface units 440 is coupled to a fiber-optic bus 450 installed to extend into all zones 400, 410, and 420 of the automobile. The processing unit 422 is also located in the truck compartment 420 and is coupled to fiber-optic bus 450. However, processing unit 422 could be coupled to the fiber-optic bus at any location in any region 400, 410, or 420 depending on space requirements.

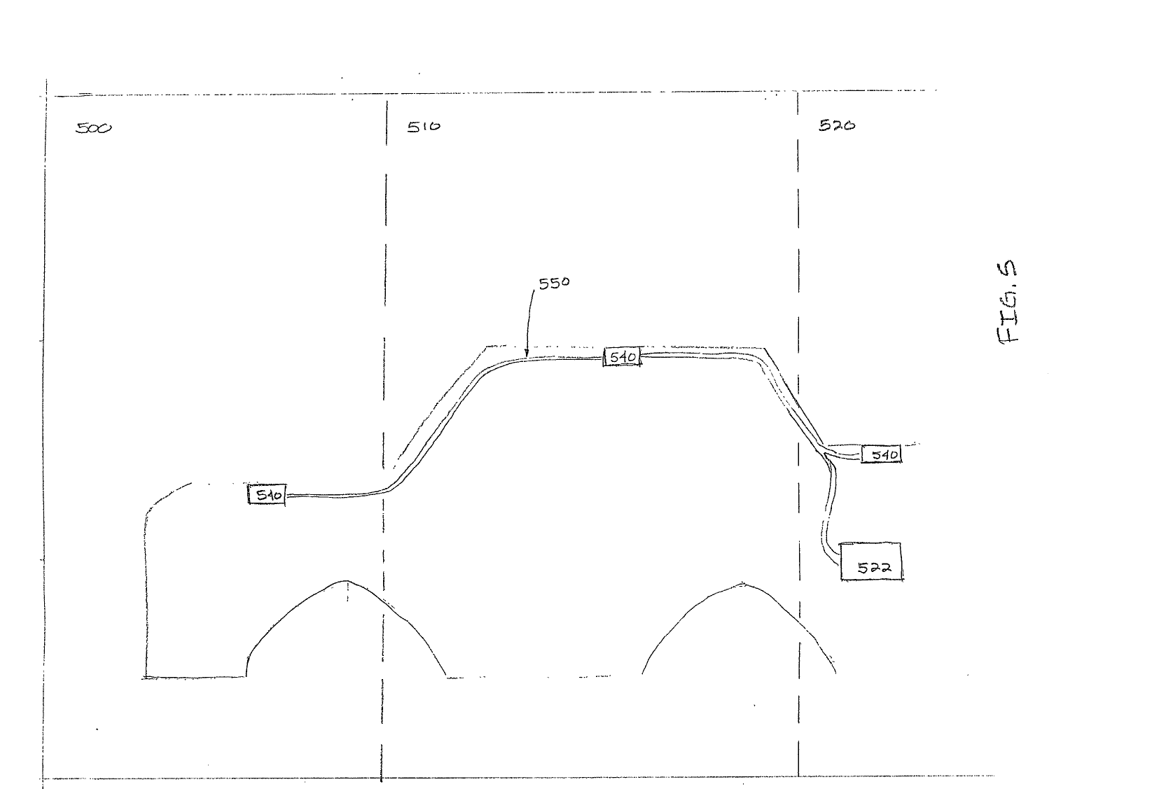

FIG. 5 is a stylized profile of an automobile illustrating the physical location of some of the components described in FIG. 4. Again, three zones 500, 510, and 520 represent the engine compartment, passenger compartment, and trunk compartment, respectively, of the automobile. The signal interface units 540 are installed underneath the hood in the engine compartment 500, underneath the dome in the passenger compartment 510, and underneath the trunk lid in the trunk compartment 520. The signal interface unit 540 in the passenger compartment 510 may even share a physical location with the dome light of the automobile. The fiber-optic bus 550 runs from the engine compartment 500 to the trunk compartment 520 and the signal interface units 540 are coupled to it. The processing unit 522 is installed on the floor of the trunk section 520 and is also coupled to the fiber-optic bus 550. The sensor devices and other automobile system devices that are linked to the signal interfaces by wireless connections are not shown, but their physical locations would be optimized in the various zones of the automobile depending upon their functionality and purpose.

Having described and illustrated the principles of the invention in a preferred embodiment thereof, it should be apparent that the invention may be modified in arrangement and detail without departing from such principles. claim is made to all modifications and variation coming within the spirit and scope of the following claims.

1. An apparatus, comprising:
a plurality of devices located inside or upon an automobile, with each device possessing a wireless link;
a graphic user interface located within said automobile, accessible to the driver of said automobile; and
a processing unit located within said automobile that exchanges signals with the devices and the graphic user interface via a plurality of wireless links.

2. The apparatus of claim 1 wherein said devices comprise a plurality of sensors, including:
IR and radar sensors;
a plurality of audio and video entertainment devices;
a plurality of automobile subsystems including environmental controls, security systems, and lighting;
a plurality of transmitters, receivers, and associated antenna; and
a plurality of Personal Digital Assistants.

3. The apparatus of claim 1 wherein said wireless links comprise analog cellular links, Cellular Digital Packet Data (CDPD) links, Satcom links, IEEE 802.11 links, and Motorola Bluetooth links.

4. The apparatus of claim 1 wherein said graphic user interface comprises a heads-up display.

5. The apparatus of claim 1 wherein said processing unit contains a plurality of inertial reference sensors.

6. An apparatus, comprising:
a graphic user interface located within said automobile, accessible to the driver of said automobile, and possessing a wireless link;
a plurality of wireless signal interface units located within said automobile that exchange signals with devices and the graphic user interface via a plurality of wireless links;
a processing unit located within said automobile; and
a fiber-optic bus connecting the wireless signal interface units and the processing unit.

7. The apparatus of claim 6 wherein said devices comprise a plurality of sensors, including:
IR and radar sensors;
a plurality of audio and video entertainment devices;
a plurality of automobile subsystems including environmental controls, security systems, and lighting;
a plurality of transmitters, receivers, and associated antenna; or
a plurality of Personal Digital Assistants.

8. The apparatus of claim 6 wherein said wireless links comprise analog cellular links, Cellular Digital Packet Data (CDPD) links, Satcom links, IEEE 802.11 links, and Motorola Bluetooth links.

9. The apparatus of claim 6 wherein said graphic user interface comprises a heads-up display.

10. The apparatus of claim 6 wherein said processing unit contains a plurality of inertial reference sensors.

11. The apparatus of claim 6 wherein there are wireless signal interface units physically located inside a hood compartment, inside a passenger compartment, and inside a trunk compartment of said automobile.

12. The apparatus of claim 11 wherein the wireless signal interface unit located inside the passenger compartment is housed within the domelight of said automobile.

13. A method for implementing a vehicular wireless network, comprising:
wirelessly transmitting input data from a plurality of devices to a processing unit located within an automobile;
wirelessly transmitting input data from a graphic user interface located within the automobile and accessible to the driver of the automobile to the processing unit;
forming a set of output data by processing the input data according to a plurality of communication, situational awareness, and vehicle management functions stored in a computer-readable memory; and
wirelessly transmitting subsets of the output data to the graphic user interface and selected ones of the plurality of devices.

14. The method of claim 13 wherein wirelessly transmitting input data from a plurality of devices includes transmitting input data from a Personal Digital Assistant.

15. The method of claim 13 wherein subsets of the input data received or the output data generated by the processing unit aboard said automobile are transmitted wirelessly to other similarly equipped automobiles to be used as input data for their respective communication, situational awareness, and vehicle management functions.

16. The method of claim 13 wherein wireless transmission comprises transmission over analog cellular links, Cellular Digital Packet Data (CDPD) links, Satcom links, IEEE 802.11 links, and Motorola Bluetooth links.

17. A method for implementing a vehicular wireless network, comprising:
wirelessly transmitting input data from a plurality of devices to a selected one of a plurality of wireless signal interface units located within an automobile;
wirelessly transmitting input data from a graphic user interface located within the automobile and accessible to the driver of the automobile to a selected one of the wireless signal interface units;
transmitting input data received on said wireless signal interface units to a processor unit via a fiber-optic bus connecting said wireless signal interface units and said processor units;
forming a set of output data by processing the input data according to a plurality of communication, situational awareness, and vehicle management functions stored in a computer-readable memory;
transmitting subsets of the output data to selected ones of the wireless signal interface units via the fiber-optic bus; and
wirelessly transmitting subsets of the output data to the graphic user interface and selected ones of the plurality of devices.

18. The method of claim 17 wherein wirelessly transmitting input data from a plurality of devices includes transmitting input data from a Personal Digital Assistant.

19. The method of claim 17 wherein subsets of the input data received or the output data generated by the processing unit aboard the automobile are transmitted wirelessly to other similarly equipped automobiles to be used as input data for their respective communication, situational awareness, and vehicle management functions.

20. The method of claim 17 wherein wireless transmission comprises transmission over analog cellular links, Cellular Digital Packet Data (CDPD) links, Satcom links, IEEE 802.11 links, and Motorola Bluetooth links.

21. A single data bus located in a vehicle, comprising:
a front section located in an engine section of the vehicle and interfacing with devices located in the engine section;
a middle section located in a passenger section of the vehicle and interfacing with devices located in the passenger section;
a rear section located in a rear section of the vehicle and interfacing with devices located in the rear section; and
the front, middle, and rear sections of the data bus each transferring data from the devices to other devices located in other sections of the vehicle through the bus.

22. A bus according to claim 21 including wireless interfaces coupled to each of the front, middle, and rear sections of the bus for communicating wirelessly with the devices.

23. A bus according to claim 22 wherein the wireless interfaces communicate with the devices using an IEEE 802.11 or Bluetooth protocol.

24. A bus according to claim 21 wherein the bus is made from a fiber optic material having a first fiberoptic strand that transfers data from any of the devices located in the trunk, passenger, and rear sections.

25. A bus according to claim 24 including a second fiberoptic strand that transfers data from any of the devices located in the trunk, passenger, and rear sections.

26. A bus according to claim 21 including a controller coupled to the bus for arbitrating data transfer requests by the different devices.

27. A bus according to claim 26 wherein the controller automatically detects any portable devices moved into any one of the engine, passenger, or rear sections and enables the portable devices to communicate with other devices coupled to the bus.

28. A bus according to claim 22 including locating separate wireless interfaces in the engine section, passenger section, and rear sections so that wireless transmissions from wireless devices in the vehicle will be shielded from the wireless interfaces in the other vehicle sections.
